(19) United States
(12) Patent Application Publication
(10) Pub. No.: US 2009/0197069 A1
(43) Pub. Date: Aug. 6, 2009

(54) Expandable Thermoplastic Resin Particles And Foamed Article Using The Same

(75) Inventors: Kirito Suzuki, Hyogo (JP); Shotaro Maruhashi, Hyogo (JP); Hidekazu Oohara, Hyogo (JP)

Correspondence Address: WESTERMAN, HATTORI, DANIELS & ADRIAN, LLP, 1250 CONNECTICUT AVENUE, NW, SUITE 700, WASHINGTON, DC, 20036, US

(73) Assignee: KANEKA CORPORATION, Osaka-shi, Osaka (JP)

(21) Appl. No.: 11/909,871

(22) PCT Filed: Mar. 28, 2006
(86) PCT No.: PCT/JP2006/306244

§ 371 Date: Sep. 27, 2007

(30) Foreign Application Priority Data
Mar. 31, 2005 (JP) 2005-101592
Aug. 26, 2005 (JP) 2005-245278
Sep. 30, 2005 (JP) 2005-287786

(51) Int. Cl. B32B 3/26; C08J 9/16

(52) U.S. Cl. 428/221; 521/56

(57) ABSTRACT

An expandable thermoplastic resin and a foamed article thereof excellent in balance between crack resistance and compression strength, which is suitable for light-weighted plastic parts, a heat insulating parts for architecture, and buffer packing materials which is used under the condition where the materials are repeatedly dropped. And expandable thermoplastic resin particles for obtaining a foamed article having crack resistance and compression strength suitable for an automobile interior and having a low combustion rate. And foamed parts for an automobile having both of high crack resistance and high compression strength. Concretely, they relates to expandable thermoplastic resin particles obtained by containing a blowing agent into a thermoplastic resin obtained by polymerizing monomer mixture, in which a macromonomer is contained in the monomer mixture and the gel content of a foamed article obtained from the expandable thermoplastic resin particle is 1 to 40% by weight.

### TECHNICAL FIELD

The present invention relates to an expandable thermoplastic resin and a foamed article thereof excellent in balance between crack resistance and compression strength, which is suitable for light-weighted plastic parts, heat insulating parts for architecture, and cushioning materials which are used under the condition where the materials are repeatedly dropped. Further, the present invention relates to foamed parts for an automobile having both of high crack resistance and high compression strength.

### BACKGROUND ART

A polystyrene foamed article obtained by foaming an expandable polystyrene resin particle in which a blowing agent is immersed is inexpensive among thermoplastic resin foamed articles, and frequently used, however, it is well known that the polystyrene foamed article is easily broken compared with other foamed articles.

In order to improve the crack resistance in polystyrene foamed articles, processes practically utilized are a process of using an impact resistance polystyrene resin (HIPS) obtained by polymerizing styrene in the presence of a conjugated diene polymer (see JP-B-47-18428, JP-A-7-90105, JP-A-11-279368, JP-A-11-228720, JP-A-11-147970, JP-A-11-21367, JP-A-8-188669, JP-A-7-11043, and JP-A-7-188452), an immersion polymerization process of polymerizing with immersing a conjugated diene monomer and the like into a styrene polymer in the particulate state (see JP-A-6-49263, WO98/29485 pamphlet, and WO2001/048068 pamphlet), a process of using a polyethylene-polystyrene copolymer (see JP-A-8-059754, JP-B-58-051010, and JP-A-62-280237) and the like.

A foamed article obtained by these processes is improved in crack resistance compared with polystyrene foamed articles; however, as a result of introducing a component more flexible than polystyrene, the compression strength of the foamed article obtained by these processes tends to become smaller, compared with polystyrene foamed articles.

As a foamed article having high crack resistance, a process in which a polyethylene foamed article and a polypropylene foamed article are used is known, however, a foamed article cannot be easily molded compared with the case of a polystyrene foamed article in these processes, and the production cost become high. Moreover, a polyethylene resin and a polypropylene resin have a glass transition temperature lower than a room temperature, which are extremely soft foamed articles within a temperature range where generally used, and these foamed articles also have the compression strength smaller than that of polystyrene foamed articles.

A process also used is a process of using an expandable AAS resin obtained by immersing a blowing agent into, what is called, an AAS resin (JP-A-2001-247709) in which acrylic ester monomers are graft-polymerized with a butadiene rubber, subsequently a graft-copolymer obtained by graft-polymerizing a styrene monomer and a vinyl cyanide compound is dispersed into an acrylonitrile-styrene resin by using an extruder etc. This process requires many steps for the preparation and the production cost is extremely high. In addition, in the case of imparting sufficient crack resistance, the compression strength of the foamed article tends to be smaller than that of polystyrene foamed articles.

Therefore, a preparation of a foamed article having large compression and high crack resistance was difficult by conventional processes.

By the way, foamed articles made of a variety of materials are used for automobile interior such as a floor spacer, tool box, and tibia pad. In the use for an automobile, it is necessary to endure the impact generated at the time when people ride on and off or when a luggage is loaded and unloaded; therefore, the crack resistance is required. The compression strength is also required so that deformation is not generated by load. Further, for the purpose of lowering risks of burning a foamed article rapidly at firing such as in the case of accidents, it is required that the combustion speed is slow, and a standard is determined, for example, according to the FMVSS No. 302 test:

In order to impart the flame retardancy, in general, using a flame retardant or a complex flame retardant in which a flame retardant and a flame retardant aid are combined is known. An example of the general flame retardant is a halogen flame retardant, and an example, of the general flame retardant aid is organic peroxide. However, when such a flame retardant and a flame retardant aid are employed for a foamed article, generally, the flame retardant and flame retardant aid inhibit polymerization, or radical species generated at heating such as at polymerization or melt-kneading causes disconnection of a molecular chain, thus, the crack resistance tends to be lowered.

According to the problems described above, there was ho foamed article which satisfies all of the properties of the crack resistance, compression strength, and low combustion speed.

Moreover, parts used for an automobile are required to be light-weighed from the viewpoint of improving energy consumption and reducing the cost, and various foamed plastics are used for many parts.

As the foamed plastic, a foamed urethane or beads foamed article in which an expanded particle is in-molded is frequently used, and a polypropylene foamed article, a styrene modified polyethylene foamed article, a polystyrene foamed article, an acrylonitrile/styrene copolymer foamed article and the like are used on various parts as automobile parts.

Foamed parts for an automobile include a lower limb protection material which is called as a tibia pad mounted between around feet and the engine room for the purpose of protecting passengers' feet in the driver's seat and the assistant driver's seat when the automobile clashes, a energy absorber for head and a side impact energy absorber mounted on the pillar of the automobile or the inside of the door, a material for raising the height of under floor called as a floor spacer which is located under the floor of the automobile, a tool box which is a storage box under the trunk room, and a bumper core mounted on the inside of the bumper and the like.

As for these foamed parts for an automobile, a foamed plastic material is determined from viewpoints of the crack resistance, compression strength, permanent stress by compression, energy absorption performance, with or without the rubbing sound, light-weighting, recycling capability and cost, however, there is no foamed plastic satisfying all of the properties so far, which is available in the market.

A polystyrene foamed article is the foamed article which can be provided most inexpensively among foamed plastics used for foamed parts for an automobile. A polystyrene foamed article is a thermoplastic resin, which is different from a foamed urethane, and thus recycling is easily carried out.

As a general tendency, when compared with the same density of a foamed article, the compression strength of a polystyrene foamed article tends to be higher than a polypropylene foamed article or styrene modified polyethylene foamed article. Since a foamed article has a tendency that the smaller the density is, the lower the compression strength is, if the same compression strength is obtained, a polystyrene foamed article can be formed to have a lower density than a polypropylene foamed article can, thus being advantageous in view of light-weighting. An acrylonitrile/styrene copolymer foamed article is inferior to a polystyrene foamed article in view of the cost, however, as for the compression strength, an acrylonitrile/styrene copolymer foamed article has the same tendency as a polystyrene foamed article has.

However, a polystyrene foamed article and an acrylonitrile/styrene copolymer foamed article tends to be more easily cracked than a polypropylene foamed article and a styrene modified polyethylene foamed article compared with the same density of the foamed article. Since the foamed article has a tendency that the smaller the density is, the worse the crack resistance becomes, in order that a polystyrene foamed article and an acrylonitrile/styrene copolymer foamed article have the same crack resistance, they needs to be formed into a foamed article having a higher density than that of a polypropylene beads foamed article and a styrene modified, polyethylene foamed article.

As described above, foamed parts for ah automobile are required to have both of the high compression strength and the high crack resistance from the viewpoints of cost and light-weighting, however, it was difficult to have both of the high compression strength and the high crack resistance.

### DISCLOSURE OF INVENTION

Namely, the present invention relates to expandable thermoplastic resin particles, which are obtained by containing a blowing agent into a thermoplastic resin obtained by a polymerizing monomer mixture, wherein a macromonomer is contained in said monomer mixture and the gel content of a foamed article obtained from said expandable thermoplastic resin particles is 1 to 40% by weight.

As preferable embodiments, the present invention relates to the expandable thermoplastic resin particles, wherein

(1) a vinyl monomer is contained in said monomer mixture,
(2) the amount of said macromonomer is 1 to 20% by weight in the monomer mixture,
(3) said vinyl monomer is a styrene monomer,
(4) said vinyl monomer is a mixed monomer of a styrene monomer and a vinyl cyanide monomer,
(5) the amount of said vinyl cyanide monomer is 10 to 30% by weight in the monomer mixture,
(6) the amount of styrene monomer contained in the expandable thermoplastic resin is at most 1000 ppm,
(7) said macromonomer is a macromonomer having at least two terminuses wherein the terminus contains at least one polymerizable reactive group,
(8) the glass transition temperature of said macromonomer is at most −20° C.,
(9) a monomer constituting a main chain in a polymer of said macromonomer is an acrylic ester monomer and/or a methacrylic ester monomer,
(10) said acrylic ester monomer is ethyl acrylate and/or butyl acrylate,
(11) at least one of polymerizable reactive groups contained at terminuses in the macromonomer is a carbon-carbon double bond,
(12) the group having a carbon-carbon double bond contained at terminuses in the macromonomer is a group represented by the following general formula (1):

—OC(O)C(R)═CH₂ (1)

(wherein R represents a hydrogen atom or an organic group having 1 to 20 carbon atoms),
(13) R represents a hydrogen atom or a methyl group,
(14) the expandable thermoplastic resin particles are obtained by containing a blowing agent into a particulate thermoplastic resin particles, and
(15) the amount of the blowing agent contained in the thermoplastic resin particles is 3 to 15% by weight.

The present invention also relates to expanded particles, which are obtained by pre-foaming the expandable thermoplastic resin particles.

The present invention also, relates to a thermoplastic resin foamed article, which is obtained by molding the expanded particles.

As preferable embodiments, the present invention relates to the thermoplastic resin foamed article, wherein

(1) the expansion ratio is at most 60 times, and
(2) the combustion speed is at most 10 cm/minute in FMVSS No. 302 test.

Further, as the result of intensive studies, the inventors of the present invention found that the foamed article having the specified density can have both of the crack resistance and the compression strength and reached the completion of the present invention.

Specifically, the present invention relates to foamed parts for an automobile comprising a foamed article having the density of 16.6 to 100 kg/m³, wherein the relationship among compression strength A (MPa) at 25% strain of said foamed article in a static compression test, a 50% failure height B (cm) in said foamed article in falling weight method, and a density C (kg/m³) of said foamed article satisfies both of the following formulas (2) and (3):

A≧0.0113×C−0.09 (2)

B≧0.9×C−3.5 (3)

As a preferable embodiment, the present invention relates to the foamed parts for an automobile, wherein said foamed article is a thermoplastic resin foamed article obtained by in-molding the expanded particles obtained by foaming the expandable thermoplastic resin particles obtained by containing the a blowing agent into the thermoplastic resin obtained by polymerizing monomer mixture comprising, a macromonomer, and wherein the gel content of said thermoplastic resin foamed article is 1 to 40% by weight, as other preferable embodiment, the present invention relates to the foamed parts for an automobile, wherein said foamed article is a thermoplastic resin foamed article obtained by in-molding the expanded particles obtained by foaming expandable thermoplastic resin particles obtained by containing a blowing agent into a thermoplastic resin obtained by polymerizing monomer mixture comprising a styrene monomer, a vinyl cyanide monomer, and an acrylic ester macromonomer having at least two terminuses wherein the terminus contains at least one polymerizable reactive group, and as other preferable embodiment, the present invention further relates to the foamed parts for an automobile, which is any one of a tibia pad, energy absorber for head, side impact energy absorber, bumper core, floor spacer and tool box.

As the result of intensive studies conducted by the inventors of the present invention in order to solve the above mentioned problems, the inventors found that a foamed article in which the combustion speed is retarded without damaging the crack resistance and the compression strength by using a halogen flame retardant and a compound which generates radical species due to high temperature decomposition having a 10 hours half-life temperature of at least 120° C. to expandable thermoplastic resin particles comprising a macromonomer, in which the gel content of a foamed article is 1 to 40% by weight can be obtained and reached the completion of the preset invention.

Specifically, the present invention relates to expandable thermoplastic resin particles, which is obtained by containing a blowing agent into a thermoplastic resin obtained by polymerizing monomer mixture comprising a macromonomer, and a halogen flame retardant and/or a compound which generates radical species due to high temperature decomposition having a 10 hours half-life temperature of at least 120° C., and the gel content of a foamed article obtained from said expandable thermoplastic resin particles is 1 to 40% by weight. As preferable Embodiments, the present invention relates to the expandable thermoplastic resin particles comprising 0.25 to 1.20 parts by weight of a halogen flame retardant and 0.1 to 0.5 parts by weight a compound which generates radical species due to high temperature decomposition having a 10 hours half-life temperature of at least 120° C. based on 100 parts by weight of the thermoplastic resin.

### BEST MODE FOR CARRYING OUT THE INVENTION

A thermoplastic resin composing the expandable thermoplastic resin particles of the present invention is characterized in that the thermoplastic resin comprises a macromonomer in a monomer mixture and the gel content of a foamed article obtained from the expandable thermoplastic resin particles is 1 to 40% by weight. The expandable thermoplastic resin particles of the present invention are obtained by containing a blowing agent into a thermoplastic resin. Herein, “containing a blowing agent” is the term of the dominant conception containing the meaning of “immersing a blowing agent”. Preferably, a vinyl monomer is further contained in the monomer mixture.

### (Macromonomer)

In the present invention, a macromonomer is referred to a high molecular weight monomer having a polymerizable reactive group in a polymer. The number average molecular weight of the macromonomer is not particularly limited, however, preferably in a range from 1000 to 200000. It is more preferably at most 100000, and the most preferably at most 40000. When the number average molecular weight is larger than 200000, the viscosity of the macromonomer becomes high, thus tends to be difficult in handling. In the present invention, it is preferable that a high molecular weight monomer having at least two terminuses wherein the terminus contains at least one polymerizable reactive group is used as a macromonomer since the gel content in a foamed article obtained from expandable thermoplastic resin particles obtained by utilizing the macromonomer is adjusted to be 1 to 40% by weight. As long as the gel content is 1 to 40% by weight, a macromonomer having one molecular terminus having a polymerizable reactive group may be existed in mixing with the macromonomer. For example, there is a case where a macromonomer having one molecular terminus having a polymerizable reactive group in the process of preparing a macromonomer having one polymerizable reactive group exists respectively at two molecular terminuses, however, the mixed macromonomer may be used as it is.

A polymerizable reactive group existing at the molecular terminus of the macromonomer is not particularly limited, but examples are an allyl group, a vinyl silyl group, a vinyl ether group, a dicyclopentadienyl group and the like, and from the viewpoint of the copolymerization reactivity with other monomers, at least one of them is preferably a carbon-carbon double bond, and further preferably a group represented by the following general formula (1):

—OC(O)C(R)═CH₂ (1)

In the formula, R is not particularly limited as long as R represents a hydrogen atom or an organic group having 1 to 20 carbon atoms, however, from the viewpoint of excellent copolymerization reactivity, particularly, a group selected from a group consisting of —H, —CH₃, —CH₂CH₃, —(CH₂)ₙCH₃ (n represents an integer of 2 to 19), —C₆H₅, —CH₂OH and —CN is preferable, and —H and —CH₃ are more preferable.

A process for preparing a polymer which is the main chain in the macromonomer used in the present invention is not particularly limited, however, the polymer is preferably prepared by radical polymerization.

A radical polymerization process can be classified into “general radical polymerization”, in which a monomer having a specific functional group and a vinyl monomer are simply copolymerized by using an azo compound, a peroxide and the like as a polymerization initiator, and “controlled radical polymerization”, which is capable of introducing a specific functional group to a controlled position such as an terminus etc.

In “the general radical polymerization”, a monomer having a specific functional group is introduced only at random into a polymer, so that this monomer is required to be used in a considerably large amount, in case of obtaining a polymer having a high functionalization ratio. The molecular weight distribution is so wide that it tends to become difficult to obtain a polymer having low viscosity since the general polymerization is free-radical polymerization.

“The controlled radical polymerization” can be further classified into “chain transfer agent process”, in which a vinyl polymer having a functional group at an terminus is obtained by polymerizing with the use of a chain transfer agent having a specific functional group, and “living radical polymerization”, in which a polymer having a molecular weight approximately as designed is obtained by a growth terminus growing without causing a termination reaction etc.

In “the chain transfer agent process”, a polymer having a high functionalization ratio can be obtained; however, a chain transfer agent having a specific functional group is required for an initiator. Also, the molecular-weight distribution of an obtained polymer is so wide that it is difficult to obtain a polymer having low viscosity since it is free-radical polymerization in the same manner as the above-mentioned “general radical polymerization”.

Unlike these polymerization processes, as described in WO 99/65963 pamphlet relating to the invention of the applicant oneself of the present invention, even though “the living radical polymerization” is radical polymerization, which is difficult to control since a polymerization speed is high and a termination reaction due to coupling of radicals each other etc are easily caused, a termination reaction hardly occurs, and a polymer in which the molecular-weight distribution is narrow (for example, Mw/Mn is approximately 1.1 to 1.5) can be obtained, and additionally, the molecular weight can to be freely controlled depending on a charge ratio of a monomer to an initiator.

Accordingly, “the living radical polymerization” is a more preferable polymerization process as a preparation process of a macromonomer having a specific functional group as described above in the present invention, since a monomer having a specific functional group can be introduced to almost arbitrary position in a polymer, besides a polymer having a narrow molecular weight distribution and low viscosity can be obtained.

Besides these, as “living radical polymerization”, examples are a process by using cobalt porphyrin complexes, as described in Journal of American Chemical Society (J. Am. Chem. Soc.) 1994, Vol. 116, page 7943, a process by using a radical capturing agent such as a nitroxide compound as described in Macromolecules, 1994, Vol. 27, page 7228, and “Atom Transfer Radical Polymerization” (ATRP) in which an organic halide, a halogenated sulfonyl compound and the like as an initiator and a transition metal complex is used as a catalyst.

Among “the living radical polymerization”, “the atom transfer radical polymerization”, in which a vinyl monomer is polymerized by using an organic halide or a halogenated sulfonyl compound as ah initiator, and a transition metal complex as a catalyst is further more preferable as a preparation process of a macromonomer having a specific functional group from the viewpoint that the polymer has a halogen and the like, which is comparatively favorable for a functional group transformation reaction, at the end, and the degree of freedom of designing an initiator and a catalyst is large, in addition to the original characteristics of “the living radical polymerization”. Examples of the atom transfer radical polymerization are described in Matyjaszewski et al., Journal of American Chemical Society, 1995, Vol. 117, page 5614, Macromolecules, 1995, Vol. 28, page 7901, Science 1996, Vol. 272, page 866, WO96/30421 pamphlet, WO97/18247 pamphlet, WO98/01480 pamphlet, WO98/40415 pamphlet, or Sawamoto et al, Macromolecules, 1995, Vol. 28, page 1721, JP-A-9-208616, and JP-A-8-41117.

Among these, it is not particularly limited which process is used as a process for preparing a macromonomer in the present invention, however, it is generally preferable to prepare a macromonomer having at least two terminuses wherein the terminus contains at least one polymerizable reactive group, in which the gel content of the foamed article is 1 to 40% by weight by the controlled radical polymerization, further, the living radical polymerization is preferably used and the atom transfer radical polymerization is the most preferably used from the viewpoint of easiness in control.

A monomer composing the polymer main chain in a macromonomer is not particularly limited, and various kinds can be used. Examples are acrylic acid monomers such as acrylic acid, methyl acrylate, ethyl acrylate, n-propyl acrylate, isopropyl acrylate, n-butyl acrylate, isobutyl acrylate, tert-butyl acrylate, n-pentyl acrylate, n-hexyl acrylate, cyclohexyl acrylate, n-heptyl acrylate, n-octyl acrylate, 2-ethylhexyl acrylate, nonyl acrylate, decyl acrylate, dodecyl acrylate, phenyl acrylate, toluoyl acrylate, benzyl acrylate, 2-methoxyethyl acrylate, 3-methoxybutyl acrylate, 2-hydroxyethyl acrylate, 2-hydroxypropyl acrylate, stearyl acrylate, glycidyl acrylate, 2-aminoethyl acrylate, an ethylene oxide adduct of acrylic acid, trifluoromethylmethyl acrylate, 2-trifluoromethylethyl acrylate, 2-perfluoroethylethyl acrylate, 2-perfluoroethyl-2-perfluorobutylethyl acrylate, 2-perfluoroethyl acrylate, perfluoromethyl acrylate, diperfluoromethylmethyl acrylate, 2-perfluoromethyl-2-perfluoroethylmethyl acrylate, 2-perfluorohexylethyl acrylate, 2-perfluorodecylethyl acrylate and 2-perfluorohexadecylethyl acrylate; methacrylic acid monomers such as methacrylic acid, methyl methacrylate, ethyl methacrylate, n-propyl methacrylate, isopropyl methacrylate, n-butyl methacrylate, isobutyl methacrylate, tert-butyl methacrylate, n-pentyl methacrylate, n-hexyl methacrylate, cyclohexyl methacrylate, n-heptyl methacrylate, n-octyl methacrylate, 2-ethylhexyl methacrylate, nonyl methacrylate, decyl methacrylate, dodecyl methacrylate, phenyl methacrylate, toluoyl methacrylate, benzyl methacrylate, 2-methoxyethyl methacrylate, 3-methoxybutyl methacrylate, 2-hydroxyethyl methacrylate, 2-hydroxypropyl methacrylate, stearyl methacrylate, glycidyl methacrylate, 2-aminoethyl methacrylate, γ-(methacryloyloxypropyl)trimethoxysilane, ethylene oxide adducts of methacrylic acid, trifluoromethylmethyl methacrylate, 2-trifluoromethylethyl methacrylate, 2-perfluoroethylethyl methacrylate, 2-perfluoroethyl-2-perfluorobutylethyl methacrylate, 2-perfluoroethyl methacrylate, perfluoromethyl methacrylate, diperfluoromethylmethyl methacrylate, 2-perfluoromethyl-2-perfluoroethylmethyl, methacrylate, 2-perfluorohexylethyl methacrylate, 2-perfluorodecylethyl methacrylate and 2-perfluorohexadecylethyl methacrylate; styrene monomers such as styrene, chlorstyrene, methyl styrene such as α-methyl styrene, t-butyl styrene, styrene sulfonate and salts thereof; fluorine-containing vinyl monomers such as perfluoroethylene, perfluoropropylene and vinylidene fluoride; silicon-containing vinyl monomers such as vinyltrimethoxysilane and vinyltriethoxysilane; maleic anhydride, maleic acid, monoalkyl ester and dialkyl ester of maleic acid; fumaric acid, monoalkyl ester and dialkyl ester of fumaric acid; maleimide monomers such as maleimide, methylmaleimide, ethylmaleimide, propylmaleimide, butylmaleimide, hexylmaleimide, octylmaleimide, dodecylmaleimide, stearylmaleimide, phenylmaleimide and cyclohexylmaleimide; nitrile group-containing vinyl monomers such as acrylonitrile and methacrylonitrile; amide group-containing vinyl monomers such as acrylamide and methacrylamide; vinyl esters such as vinyl acetate, vinyl propionate, vinyl pivalate, vinyl benzoate and vinyl cinnamate; alkenes such as ethylene and propylene; conjugated dienes such as butadiene and isoprene; allyl chloride, and allyl alcohol. These may be used alone or polymerized by using a plurality of these. Among these, styrene monomers, acrylic acid monomers and methacrylic acid monomers are preferable in view of physical properties of products. Acrylic ester monomers and methacrylic ester monomers are more preferable, acrylic ester monomers are further more preferable, ethyl acrylate and butyl acrylate are particularly preferable, and butyl acrylate is the most preferable. In the present invention, the above described monomers may be copolymerized with other monomers, and at that time, the above monomers are preferably contained in an amount of at least 40% by weight.

The glass transition temperature of the macromonomer is preferably at most −20° C., more preferably at most −30° C., and further more preferably at most −40° C. If the glass transition temperature is more than −20° C., since the flexibility of the obtained thermoplastic resin particles is lowered, it tends that foaming takes long time and the vapor pressure at molding becomes high in order to fuse the expanded particles.

As for a macromonomer used in the present invention, the molecular weight distribution, namely, the ratio (Mw/Mn) between weight average molecular weight and number average molecular weight measured by gel permeation chromatography (hereinafter, may be abbreviated, as GPC) is preferably at most 1.8, more preferably at most 1.6, and particularly preferably at most 1.4. When the GPC measurement is performed in the present invention, generally, polystyrene gel columns etc are used by utilizing chloroform or tetrahydrofuran as an eluent, and the value of molecular weight is found by polystyrene conversion and the like. A macromonomer having a wide molecular weight distribution has a fear that the progression of a copolymerization reaction becomes ununiform and has a possibility that an unreacted macromonomer remains.

The amount of a macromonomer in a monomer mixture composing thermoplastic resin particles in the present invention is preferably 1 to 20% by weight. It is more preferably 2 to 15% by weight, and particularly preferably 4 to 10% by weight. When the amount of the macromonomer in the monomer mixture is less than 1% by weight, the effect of improving crack resistance tends to become small, and when it is more than 20% by weight, there is a tendency that foaming takes a long time.

### (Other Monomers)

In the monomer mixture composing the thermoplastic resin particles in the present invention, a monomer component other than the macromonomer is not particularly limited, however, it is preferable to use a vinyl monomer.

As a vinyl monomer, examples are a styrene monomer, a vinyl cyanide monomer, an acrylic acid monomer, and a methacrylic acid monomer.

As a styrene monomer used in the present invention, examples are styrene, methyl styrene such as α-methyl styrene and paramethyl styrene, t-butyl styrene, chlorstyrene styrene, and styrene derivatives such as styrene sulfonate and salts thereof. These monomers can be used alone or at least two kinds of these can be used in combination. Among these, styrene is particularly preferable. A bifunctional or multifunctional monomer such as vinyl styrene may be copolymerized with those monomers.

As a vinyl cyanide monomer used in the present invention, examples are acrylonitrile and methacrylonitrile. These monomers can be used alone or in combination. Among these, acrylonitrile is particularly preferable.

A variety of kinds of monomers such as maleic anhydride, maleic acid, monoalkyl ester and dialkyl ester of maleic acid, fumaric acid, monoalkyl ester and dialkyl ester of fumaric acid, maleimide monomers, and amide group-containing vinyl monomers such as acrylamide and methacrylamide may be copolymerized within the range where the object of the present invention is not damaged.

Among these vinyl monomers, it is preferable to use a styrene monomer or a mixture of a styrene monomer and a vinyl cyanide monomer in the viewpoint easiness in foam-molding.

When a styrene monomer is used, the amount to be added is preferably 50 to 99% by weight in the monomer mixture, and more preferably 60 to 98% by weight. When the amount is less than 50% by weight, there is a tendency that the effect of improving the foam-moldability by a styrene monomer is lowered.

When a vinyl cyanide monomer is used, the amount to be used is preferably 10 to 30% by weight in the monomer mixture, and more preferably 12 to 25% by weight. In this range, the effects such as the heat resistance and the oil resistance due to cyanide vinyl are easily obtained, and a pre-foaming time does not tend to take too long. When the amount is less than 10% by weight, the effect for using a vinyl cyanide monomer tend to hardly appear, and when it is more than 30% by weight, there is a tendency that it takes an extremely long time to foam.

### (Polymerization)

In the present invention, thermoplastic resin particles are obtained by polymerizing monomer mixture containing a macromonomer. A process of polymerizing these is not particularly limited, however, it is preferable that the monomer mixture are subjected to aqueous polymerization, and further, the monomer mixture are preferably polymerized by carrying out at least one polymerization selected from an emulsion polymerization, a suspension polymerization, a microsuspension polymerization.

As a suspension stabilizer used in the present invention, examples are water soluble macro molecules such as polyvinyl alcohol, methyl cellulose, polyvinyl pyrrolidone and polyacrylamide; and inorganic salts which are hard to be solved such as magnesium pyrophosphate, calcium phosphate and hydroxyapatite, and a surfactant may be used in combination. When an inorganic salt which is hard to be salved is used, it is preferable to use anionic surfactants such as sodium alkylsulfonate and sodium dodecylbenzene sulfonate in combination.

As a polymerization initiator used in polymerizing the monomer mixture in the present invention, a polymerization initiator which generates radicals used for preparing a thermoplastic polymer used for preparing a thermoplastic polymer can be generally used, and representative examples are organic peroxides such as benzoyl peroxide, lauroyl peroxide, t-butyl perbenzoate, t-butyl perpivalate, t-butyl peroxyisopropyl carbonate, t-butylperoxyacetate, 2,2-di-t-butylperoxybutane, di-t-butylperoxy hexahydroterephthalate, 1,1-di(t-butylperoxy)-3,3,5-trimethylcyclohexane, 1,1-di(t-butylperoxy)cyclohexane, 1,1-di(t-amylperoxy)-3,3,5-trimethylcyclohexane, and 1,1-di(t-amylperoxy)cyclohexane; and azo compounds such as azobisisobutylonitrile, and azobisdimethylvaleronitrile. These polymerization initiators can be used alone or at least two kinds of these can be used in combination.

In polymerization of the above described monomer mixture in the present invention, a mercaptan chain transfer agent such as n-octyl mercaptan, n-dodecyl mercaptan and t-dodecyl mercaptan, and α-methyl styrene dimer which is generally used for polymerization of an acrylonitrile-styrene resin may be used as a polymerization adjuster. It is preferable to use α-methyl styrene dimer since the odor of the foamed article is reduced.

Moreover, a plasticizer may be added to the expandable thermoplastic resin particles of the present invention to adjust the foaming property and the like. A conventional plasticizer can be used, however, in the case where it is necessary to reduce the diffusion of a volatile organic component from the foamed article, a plasticizer having a high boiling point or a plasticizer in which a boiling point does not exist at an ordinary pressure may be used. Specific examples are phthalate esters such as dioctyl phthalate, di-2-ethylhexyl phthalate, dibutyl phthalate and butylbenzyl phthalate; fatty acid esters such as dibutyl sebacate, dioctyl adipate and diisobutyl adipate; and glycerin fatty acid esters such as a palm kernel oil, palm oil, rape seed oil, rape seed hydrogenated fractionation oil and curing soy bean oil. These are used alone or at least two kinds are used in combination.

The polymerization initiator, the chain transfer agent, the polymerization adjuster, the plasticizer etc may be used in an amount to be added which is usually used, and the amount is not particularly limited.

Furthermore, additives such as a flame retardant, ultraviolet ray absorber, antistatic agent, conducting agent, and particle size distribution adjuster, which are usually used for preparing expandable polystyrene resin particles, can be appropriately added.

As a concrete process for obtaining the expandable thermoplastic resin particles of the present invention, an examples is a process in which a macromonomer and, for example, a styrene monomer and a vinyl cyanide monomer are dispersed into an aqueous medium in the presence of a polymerization initiator and other additives, thereafter, a polymerization reaction is initiated, and thereto is added a blowing agent during the polymerization, or a blowing agent is contained after the polymerization.

### (Blowing Agent)

As a blowing agent which can be used in the present invention, a volatile blowing agent having a boiling point of at most 80° C. can be used, such as aliphatic hydrocarbons such as propane, normal butane, isobutane, normal pentane, isopentane and hexane, alicyclic hydrocarbons such as cyclohexane, cyclopentane and cyclobutane, which are generally known, and further, halogenated hydrocarbons such as trifluoromonochloroethane and difluorodichloromethane. In addition, these can be used alone or at least two kinds can be used in combination. In order to reduce contraction and deformation in molding, butane and/or pentane are preferably used as the blowing agent, and butane is particularly preferable.

In the present invention, it is preferable to prepare expandable thermoplastic resin particles by containing a blowing agent into thermoplastic resin particles in the particulate state from the viewpoint of the production efficiency. As a process thereof, the blowing agent may be added during the polymerization process, or after terminating the polymerization process.

As for a blowing agent, a blowing agent in the expandable thermoplastic resin particles is generally provided in an amount of preferably about 3 to about 15% by weight. It is more preferably 4 to 10% by weight. When the amount is less than 3% by weight, the sufficient foaming property does not tend to be obtained, and when it more than, 15% by weight, contraction and deformation in molding tend to become large.

### (Molecular Weight)

The weight average molecular weight of a tetrahydrofuran soluble portion in the expandable thermoplastic resin particles used in the present invention is preferably 100,000 to 500,000. Also from the viewpoint of the quality of a foamed article, it is more preferably at most 450,000, it is further more preferably at most 400,000, particularly preferably at most 350,000, and the most preferably at most 250,000. Moreover, it is preferably at least 150,000, and more preferably at least 200,000. When the weight average molecular weight is less than 100,000, the strength of the obtained foamed article tends to become smaller, and when the weight average molecular weight is more than 500,000, it tends to take too long time for the foamed article to have a high expansion ratio at the time of pre-foaming. In this range of the molecular weight, a foamed article having a generally used expansion ratio can be easily obtained and a foamed article having sufficient strength can be also easily obtained.

In the present invention, the measurement of the weight average molecular weight of a tetrahydrofuran soluble portion in the expandable thermoplastic resin particles is calculated by the standard polystyrene conversion using gel permeation chromatography (GPC). 0.2 g of the expandable thermoplastic resin particles is charged into 20 ml of tetrahydrofuran, after agitating for 8 hours, the supernatant liquid of the tetrahydrofuran solution was collected, and the measurement of the weight average molecular weight of a solution filtered by a 2 μm-thickness filter is carried out.

### (Amount of Volatile Organic Compound)

In the use for an automobile, generally, the amount of a volatile organic compound is preferably small. Herein, a volatile organic compound is referred to styrene, toluene, ethylbenzene, and a remaining unreacted substance in a monomer used for the polymerization, which are possibly contained in the present invention. The amount of a volatile organic compound contained in the expandable thermoplastic resin particles, pre-foamed particles and a foamed article in the present invention is preferably at most 1000 ppm, and more preferably at most 500 ppm. It is particularly preferable that a volatile organic compound is not detected.

As for the measurement of the amount of a volatile organic compound contained in the expandable thermoplastic resin particles of the present invention, 0.2 g of the expandable thermoplastic resin particles are charged into 20 ml of methylene chloride, after agitating for 8 hours, the supernatant liquid of the methylene chloride solution is collected, and the amount of a volatile organic compound contained is measured by gas chromatography.

From the viewpoint that it is necessary to reduce the diffusion of a volatile organic component from a foamed article, the amount of a styrene monomer contained in the expandable thermoplastic resin of the present invention is preferably at most 1000 ppm, and it is more preferably at most 500 ppm. It is particularly preferable that a styrene monomer is not detected. As a process for measuring the amount of a styrene monomer, the above described process for measuring the amount of a volatile organic compound can be adopted.

### (Expanded Particle)

In order to obtain a foamed article from expandable thermoplastic resin particles in the present invention, a process of directly in-molding an expandable thermoplastic resin particles, or a process of pre-foaming an expandable thermoplastic resin particles into expanded particles and in-molding thereof is exemplified, however, in the present invention, from the viewpoint of easiness in adjusting a density of the foamed article, it is preferable to pre-foam expandable thermoplastic resin particles into expanded particles. As a pre-foaming process, an example is a general pre-foaming process for foaming by heating with steam etc using a cylindrical-shaped pre-foaming machine.

### (Amount of Gel)

It is necessary that the gel content of a foamed article obtained from the expandable thermoplastic resin particles of the present invention is 1 to 40% by weight. When the gel content is less than 1% by weight, it tends that the efficient effect of improving the crack resistance can not be obtained, and when the gel content is more than 40% by weight, it tends to take a long time to be foamed. As a range where the foaming property and the fusing property at molding, the gel content is preferably at most 20% by weight, and particularly preferably at most 15% by weight.

In the measurement of the gel content of a foamed article obtained by the expandable thermoplastic resin particles of the present invention, 20 sheets of test pieces having a predetermined size are cut out from the foamed article, and the extraction is carried out by boiling xylene, using 80 g of xylene per 1 g of the foamed article. After passing two hours from the initiation of boiling, filtration was carried out by a 200-mesh wire screen and the filtered solution was removed, thereafter, extraction of the filtered matter was carried out again by boiling xylene for 2 hour from the initiation of boiling. The filtration was carried out again by a 200-mesh wire screen and the filtered solution was removed, thereafter the extraction of the filtered matter was carried out again by boiling xylene for 1 hour from the initiation of boiling, and the filtration was carried out by a 200-mesh wire screen, and the filtrate was obtained as a gel portion which was not extracted by the boiling xylene. The obtained gel portion is dried by a dryer at 150° C. for one hour, and the ratio based on the original weight of the foamed article is regarded as gel content.

### (Foamed Article)

As for a foamed article obtained from the expandable thermoplastic resin particles of the present invention, a general process such as a process of filling the expanded particles within a die, and heating by blowing steam etc to foam can be adopted. There is a tendency that the lower the expansion ratio is, the more excellent the compression strength, crack resistance and combustion speed are, and in order to obtain sufficient performance, the expansion ratio is preferably at most 60 times, and more preferably at most 50 times. Herein the ratio is referred to the volume of the foamed article being divided by the weight, and the unit is represented by cm³/g.

From the viewpoint that a foamed article in which a combustion speed is delayed without damaging the crack resistance and the compression strength can be obtained, it is more preferable to prepare expandable thermoplastic resin particles further containing a halogen flame retardant and a compound which generates radical species due to high temperature decomposition having a 10 hours half-life temperature of at least 120° C. The halogen flame retardant is particularly preferably in an amount of 0.25 to 1.20 parts by weight based on 100 parts by weight of a thermoplastic resin.

In the present invention, known and conventional halogen flame retardants can be used. Examples are a halogenated aliphatic hydrocarbon compounds such as hexabromocyclododecane, tetrabromodecane and hexabromocyclohexane; brominated phenols such as tetrabromobisphenol A, tetrabromobisphenol F, and 2,4,6-tribromophenol; brominated phenol derivatives such as tetrabromobisphenol A-bis(2,3-dibromopropyl ether), and tetrabromobisphenol A-diglycidyl ether; and a brominated polymer such as brominated polystyrene. Among these, a halogenated aliphatic hydrocarbon compound is preferable from the viewpoint that the retardant effect of the combustion speed in use for a foamed article is excellent considering the balance between a decomposition temperature and a combustion speed of the foamed article, and hexabromocyclododecane is particularly preferable. The amount to be used is preferably 0.25 to 1.20 parts by weight based on 100 parts by weight of the thermoplastic resin, and more preferably 0.5 to 1.0 parts by weight. In this range, the retardant effect of the combustion speed can be obtained without largely lowering the crack resistance of the foamed article.

In the present invention, examples of a compound which generates radical species due to high temperature decomposition having a 10 hours half-life temperature of at least 120° C. are 2,3-dimethyl-2,3-diphenylbutane, di-t-butyl peroxide, p-menthane hydroperoxide, 2,5-dimethyl-2,5-di(t-butylperoxy)hexyne-3, diisopropylbenzene hydroperoxide, 1,1,3,3-tetramethylbutyl hydroxyperoxide, cumene hydroxyperoxide, t-butyl hydroxyperoxide and t-hexyl hydroxyperoxide. Considering the stability at the time of polymerizing and processing, a compound which generates radical species due to high temperature decomposition having a 10 hours half-life temperature of at least 150° C. is preferable, and a compound which generates radical species due to high temperature decomposition having a 10 hours half-life temperature of at least 200° C. particularly preferable. These are used alone and at least two kinds of these are used by mixing. The amount to be used is not particularly limited, however, it is preferably 0.1 to 0.5 parts by weight based on 100 parts by weight of a thermoplastic resin and more preferably 0.1 to 0.4 parts by weight from the viewpoint that the retardant effect of the combustion speed can be obtained without largely lowering the crack resistance of the foamed article.

The foamed parts for an automobile of the present invention is foamed parts for an automobile comprising a foamed article having the density of 16.6 to 100 kg/m³, wherein the relationship among compression strength A (MPa) at 25% strain of said foamed article in a static compression test, a 50% failure height B (cm) in said foamed article in falling weight method of the foamed article, and a density C (kg/m³) of said foamed article satisfies both of the following formulas (2) and (3):

A≧0.0113×C−0.09 (2)

B≧0.9×C−3.5 (3)

Due to having the above described properties, the foamed parts for an automobile of the present invention are favorably used for parts such as a tibia pad, energy absorber for head, side impact energy absorber, bumper core, floor spacer and tool box, where buffering and/or absorbing the impact in the automobile are required and the load capacity is necessary. Among these, the foamed parts for an automobile of the present invention are more preferably used for a tibia pad, energy absorber for head, side impact energy absorber and bumper core.

In order to further save the weight, the foamed article satisfies both of the following general formulas (4) and (5):

A≧0.0113×C−0.083 (4)

B≧0.9×C−2.8 (5)

and further, the foamed article satisfies both of the following general formulas (6) and (7):

A≧0.0113×C−0.075 (6)

B≧0.9×C−2.10 (7)

As for a foamed article used for foamed parts for an automobile of the present invention, a kind of resins thereof is not particularly limited as long as the foamed article satisfies the above formulas (2) and (3), however, from the viewpoint of recycling, it is preferable to use a thermoplastic resin obtained by polymerizing a monomer mixture containing a macromonomer, concretely, it is preferable to use a thermoplastic resin foamed article having the gel content of 1 to 40% by weight, which is prepared by in-molding expanded particles obtained by foaming expandable thermoplastic resin particles obtained by containing a blowing agent into a thermoplastic resin prepared by polymerizing a monomer mixture containing a macromonomer.

Further, it is preferable to use a thermoplastic resin obtained by, polymerizing a monomer mixture comprising a styrene monomer, a vinyl cyanide monomer and an acrylic ester macromonomer having at least two terminuses wherein the terminus contains at least one polymerizable reactive group, and concretely, it is preferable to use a thermoplastic resin foamed article obtained by in-molding expanded particles obtained by foaming expandable thermoplastic resin particles, in which a blowing agent is contained into a thermoplastic resin obtained by polymerizing a monomer mixture comprising a styrene monomer, a vinyl cyanide monomer and an acrylic ester macromonomer having at least two terminuses wherein the terminus contains at least one polymerizable reactive group.

Moreover, concretely, the above described thermoplastic resin foamed article can be preferably used.

### EXAMPLES

Hereinafter, Examples and Comparative Examples are exemplified, however, the present invention is not limited thereto. “Part” and “%” represent the weight standard as long as not particularly mentioned.

### < Preparation of Macromonomer>

In the following preparation example of a macromonomer, the number average molecular weight and the molecular weight distribution (ratio of weight average molecular weight and number average molecular weight) was calculated by the standard polystyrene conversion using gel permeation chromatography (GPC). A column in which a polystyrene crosslinked gel was filled (Shodex GPC K-804; manufactured by Showa Denko K.K.) was used as a GPC column, and chloroform was used as a GPC solvent. In the following preparation example of a macromonomer, the glass transition temperature of the macromonomer was measured by DSC.

### PREPARATION EXAMPLE 1

### Synthesis of N-Butyl Polyacrylate Having Acryloyl Groups at Both Terminuses

The synthesis was carried out based on the processes described in Preparation Example 2 and Example 2 of JP-A-2004-203932. The number average molecular weight of a macromonomer after purification was 25,600, the molecular weight distribution was 1.25, and the glass transition temperature was −54° C.

### Example 1

### Preparation of Expandable Thermoplastic Resin Particles

A 6 L-autoclave equipped with a rotational agitator was charged with 2250 g of distilled water, 3.5 g of calcium tertiary phosphate; and 0.14 g of α-olefin sodium sulfonate. Then, 6 g of benzoyl peroxide, 3.5 g of 1,1-di(t-butylperoxy)cyclohexane, 4.5 g of 2,4-diphenyl-4-methyl-1-pentene and 22.5 g of a palm oil were dissolved into the mixture solution of 1777.5 g of styrene, 337.5 g of acrylonitrile, 135 g of the macromonomer having acryloyl groups at both terminuses prepared in Preparation Example 1, and the mixture was charged into the autoclave. Next, after raising a temperature in the autoclave up to 85° C. and polymerizing at the same temperature for 4 hours, 180 g of mixed butane (weight ratio: normal/iso= 75/25) was charged with pressure, thereafter, a temperature in the autoclave was raised to 115° C., and the mixed butane was immersed into the generated polymer particles by taking for 8 hours. Subsequently, the reaction system was gradually cooled down to a temperature of 30° C., and the polymerization was terminated.

The obtained expandable thermoplastic resin particles were dehydrated by a centrifugal machine, and after drying, classified by the particles diameter in a range from 0.84 to 1.19 mm.

### <Analysis of Expandable Thermoplastic Resin Particle>

### (Measurement of Molecular Weight)

The measurement of the weight average molecular weight of the expandable thermoplastic resin particles in the present invention was calculated by the standard polystyrene conversion using gel permeation chromatography (GPC) (GPC, HLC-8020 manufactured by TOSH CORPORATION., column: TSK gel GMHXL 30 cm×2, column temperature: 35° C., flow rate: 1 ml/min). Tetrahydrofuran was used as a GPC solvent.

A sample bottle in which 0.2 g of the expandable thermoplastic resin particles were contained was charged with 20 ml of tetrahydrofuran, and agitated for 8 hours, thereafter, the supernatant liquid of the tetrahydrofuran solution was collected, and the measurement of the weight average molecular weight was carried out by utilizing a solution filtered by a filter having a thickness of 0.2 μm (Myshori disk H-13-2 manufactured by TOSOH CORPORATION).

### (Measurement of Styrene Amount)

A sample bottle in which 0.2 g of the expandable c thermoplastic resin particles are contained is charged with 20 ml of methylene chloride and agitated for 8 hours, thereafter, the supernatant liquid of the methylene chloride solution is collected, and the measurement is conducted by utilizing gas chromatography (GC-14B manufactured by Shimadzu Corporation., column: 3 m, column packing PEG-20M 25%, column temperature: 110° C.).

### (Analysis of Gel Content)

A process of measuring the gel content of a foamed article obtained by foaming and molding expandable thermoplastic resin particles of the present invention is explained in the following. 20 sheets of test pieces having the size of a height of 10 mm, a width of 10 mm, and a thickness of 2 mm were cut out from the foamed article. A weight of the test piece before extraction was assumed to be A g. 80 g of xylene per 1 g of the foamed article was used and the extraction was carried out by boiling xylene within a round flask equipped with a reflux condenser. After 2 hours passed from the initiation of boiling, filtration was carried out by a 200-mesh wire screen and the filtered solution was removed, thereafter, extraction of the filtered matter was carried out again by boiling xylene for 2 hour from the initiation of boiling. The filtration was carried out again by a 200-mesh wire screen and the filtered solution was removed, thereafter the extraction of the filtered matter was carried out again by boiling xylene for 1 hour from the initiation of boiling, and the filtration was carried out by a 200-mesh wire screen to obtain a gel portion which was not extracted by the boiling xylene.

Xylene was evaporated by drying the obtained gel portion by a dryer at 150° C. for 1 hour. After being stood to cool at room temperature, the weight of the gel portion B g was measured. The calculation of the gel content is conducted by the following formula, gel content (% by weight)−B/A×100 (% by weight).

### (Measurement of the Amount of a Blowing Agent)

The amount of a blowing agent was measured by the loss in weight by heating at 150° C. for 30 minutes. The amount was 8.2% by weight.

### <Preparation of Foamed Article>

Pre-formed particles were obtained by pre-foaming expandable thermoplastic resin particles into 30 times of volume magnification. After this pre-foamed particles were aged at a room temperature for one day, then, filled within a metallic cavity having a size of 300×600×25 mm, and the expandable thermoplastic resin particles were heated with water vapor (0.1 MPa) for 20 seconds to obtain a foamed article.

### <Measurement of Physical Properties>

### (Falling Weight Method)

The falling weight method indicating the strength of crack resistance of the foamed article was carried out in accordance with JIS K 7211. A test piece having a size of 200 mm×40 mm×20 mm was cut out by a vertical slicer equipped with a saw blade from the foamed article. Two of surfaces having a size of 200 mm×40 mm were existed in the test piece, and one of these surface is to be a surface skin of, the foamed article (a surface skin of the foamed article is referred to a portion exposed on the surface of the foamed article at the time when the foamed article is molded, and is different from the inside of the foamed article cut out by a vertical slicer) which was left as it was, and the other one is to be a surface cut out by the vertical slicer equipped with a saw blade. The two surfaces having a size of 200 mm×20 mm and the two surfaces having a size of 40 m×20 mm were to be surfaces cut out by the vertical slicer. 20 pieces of the test pieces were prepared.

Assuming the surface having the surface skin in the test piece as a surface on which a falling ball strikes, 321 g of a rigid ball is dropped. The height at which the half of the test pieces was broken is found by the specified calculation formula described below. It is indicated that the larger the value is, the larger the crack resistance is.

$${H}_{50} = {H}_{i} + [ \frac{\sum ( i \cdot {n}_{i} )}{N} \pm 0.5 ]$$

H50: height at which the half are broken (cm)
Hi: test height (cm) when the height level (i) is 0, and the height at which the test piece is expected to be broken
d: height interval (cm) when the test height is raised up and lowered down
i: height level which is increased or reduced by one each (i= . . . −3, −2, −1, 0, 1, 2, 3 . . . ), assuming H1 as 0
ni: number of the test pieces which are broken (or not broken) at each level
N: total number of the test pieces which are broken (or not broken) (N=Σni). Either of data which is larger is used. In the case where the number is the same with one another, either of them may be used.
±0.5: when the broken data is used, it is minus, and when the data not broken is used, it is plus.

### (Compression Strength)

The test for examining compression strength of the foamed article was carried out in accordance with JIS K 7220. The test piece haying a size of 50 mm×50 mm×25 mm was cut out by a vertical slicer equipped with a saw blade from the foamed article. A thickness of 20 mm was left to be the thickness of the foamed article as it is. Specifically, two surfaces having a size of 50 mm×50 mm were left as the surface skin is, and four surfaces having a size of 50 mm×25 mm are surfaces cut out by the vertical slicer.

The surfaces having the surface skin were placed to be upper and lower surfaces each other and the compression test was carried out at the test speed of 10 mm/min. The value of compression strength is represented by a stress at the time when 25% of the test piece was compressed.

TABLE 1

| | | | | | | Com. | Com. | Com. | Com. | Com. | Com. |
|---|---|---|---|---|---|---|---|---|---|---|---|
| | | Ex. 1 | Ex. 2 | Ex. 3 | Ex. 4 | Ex. 1 | Ex. 2 | Ex. 3 | Ex. 4 | Ex. 5 | Ex. 6 |
| styrene | % by | 79.0 | 71.5 | 77.0 | 74.6 | | | | | 75.9 | 53.3 |
| | weight | | | | | | | | | | |
| acrylonitrile | % by | 15.0 | 22.5 | 15.0 | 23.4 | | | | | 23.8 | 16.7 |
| | weight | | | | | | | | | | |
| macromonomer | % by | 6.0 | 6.0 | 8.0 | 2.0 | | | | | 0.3 | 30.0 |
| | weight | | | | | | | | | | |
| weight average | ×10⁴ | 24.2 | 24 | 23.2 | 20.2 | 30 | 27 | 32 | 32 | 20 | 19 |
| molecular weight | | | | | | | | | | | |
| remaining styrene | ppm | ND* | ND* | ND* | ND* | 4800 | 4900 | ND* | ND* | ND* | ND* |
| amount | | | | | | | | | | | |
| gel content | % by | 6.3 | 9.4 | 10.8 | 2.7 | 0 | 21.0 | 3.4 | 11 | 0.3 | 62.0 |
| | weight | | | | | | | | | | |
| falling weight | cm | 35 | 34 | 34 | 28 | 21 | 34 | 19 | 11 | 21 | — |
| method | | | | | | | | | | | |
| compression test | kgf/cm² | 3.2 | 3.2 | 3.1 | 3.2 | 3.2 | 2.7 | 3.1 | 2.9 | 3.2 | — |

### Example 2

Example 2 was carried out in the same manner as Example 1 except that the amount of styrene to be charged was 1609.5 g and the amount of acrylonitrile to be charged was 505.5 g.

### Example 3

A molded article was prepared in the same manner as Example 1 except that the amount of styrene to be charged was 1732.5 g and the amount of a macromonomer having acryloyl groups at both terminuses was 180 g.

### Example 4

A molded article was prepared in the same manner as Example 1 except that the amount of styrene to be charged was 1678 g, the amount of acrylonitrile to be charged was 527 g and the amount of a macromonomer having acryloyl groups at both terminuses was 45 g.

### Comparative Example 1

A molded article was prepared in the same manner as Example 1 except for employing expandable polystyrene resin particles (product name: KANEPEARL NSG available from KANEKA CORPORATION).

### Comparative Example 2

Foamed modified styrene resin particles were obtained in accordance with the description of Example 2 in WO2001/048068. Except for that, a molded article was prepared in the same manner as Example 1.

### Comparative Example 3

A molded article was prepared in the same manner as Example 1 except that the amount of styrene to be charged was 2250 g, the amount of acrylonitrile to be charged was 0 g, the amount of a macromonomer having acryloyl groups at both terminuses to be charged was 0 g, and 0.45 g of divinylbenzene was added.

### Comparative Example 4

A molded article was prepared in the same manner as Example 1 except that the amount of styrene to be charged was 2250 g, the amount of acrylonitrile to be charged was 0 g, the amount of a macromonomer having acryloyl groups at both terminuses to be charged was 0 g, and 1.35 g of divinylbenzene was added.

### Comparative Example 5

A molded article was prepared in the same manner as Example 1 except that the amount of styrene to be charged was 1707.1 g, the amount of acrylonitrile to be charged was 536.1 g, and the amount of a macromonomer having acryloyl groups at both terminuses to be charged was 6.75 g.

### Comparative Example 6

Comparative Example 6 was carried out in the same manner as Example 1 except that the amount of styrene to be charged was 1198.6 g, the amount of acrylonitrile to be charged was 376.4 g, and the amount of a macromonomer having acryloyl groups at both terminuses to be charged was 675 g. The obtained expandable thermoplastic resin particles were pre-foamed, but the expandable thermoplastic resin particles were foamed only up to 3.2 times of the volume magnification. The pre-foamed particles were tried to be molded, however, they were not fused at all, and a foamed article which could be evaluated was not obtained.

The foamed article obtained in the present invention was excellent in balance between the compression strength and the crack resistance as shown in Table 1.

### Example 5

A 6 L-autoclave equipped with a rotational agitator was charged with 2486 g of distilled water, 3.5 g of calcium tertiary phosphate, and 0.14 g of α-olefin sodium sulfonate. Then, 8.02 g of benzoyl peroxide, 4.77 g of 1,1-di(t-butylperoxy)-3,3,5-trimethylcyclohexane, 16.95 g of hexabromocyclododecane, 8.86 g of 2,3-dimethyl-2,3-diphenylbutane, 4.5 g of 2,4-diphenyl-4-methyl-1-pentene and 22.5 g of a palm oil were dissolved into the mixture solution of 1785.4 g of styrene, 339.0 g of acrylonitrile, 135.6 g of the macromonomer having acryloyl groups at both terminuses prepared in Preparation Example 1 and the mixture was charged into the autoclave. Next, after raising a temperature in the autoclave up to 85° C. and polymerizing at the same temperature for 4 hours, 135.6 g of mixed butane (weight ratio: normal/iso=75/25) was charged with pressure, thereafter, a temperature in the autoclave was raised to 114° C.; and the mixed butane was immersed into the generated polymer particles by taking for 5 hours. Subsequently, the reaction system was gradually cooled down to a temperature of 30° C., and the polymerization was terminated.

The obtained expandable thermoplastic resin particles were dehydrated by a centrifuging machine, and after drying, classified by the particles diameter in a range from 0.71 to 1.40 mm. Further, formed particles were obtained by pre-foaming the expandable thermoplastic resin particles into 30 times of the volume magnification. This expanded particles were aged at a room temperature for one day, then filled within a metallic die cavity having a size of 300×600×25 mm, and the expanded particles were heated with water vapor having 0.08 MPa for 20 seconds to obtain a foamed article.

### <Analysis of Expandable Thermoplastic Resin Particles>

The measurement of molecular, weight and the analysis of gel content were carried out according to the above-described processes.

### (Measurement of Amount of Volatile Organic Compound)

As for the measurement of the amount, of a volatile organic compound contained in the expandable thermoplastic resin particles of the present invention, 0.2 g of the expandable thermoplastic resin particles were charged into 20 ml of methylene chloride, after agitating for 8 hours, a supernatant liquid of the methylene chloride solution was collected, and the measurement was conducted by utilizing gas chromatography (GC-14B manufactured by Shimadzu Corporation., column: 3 m, column packing: PEG-20M 25%, column temperature: 110° C.).

### (Measurement of Amount of Blowing Agent)

The amount of the blowing agent was measured by loss in weight by heating at 150° C. for 30 minutes. It was 5.7% by weight.

### <Measurement of Physical Properties>

The falling weight method and the measurement of the compression strength were carried out according to the above-described processes.

### (Combustion Speed)

The test for examining the combustion speed of a foamed article is carried out in accordance with FMVSS No. 302. The test piece having a length of 355.6 mm×width of 101.6 mm and a thickness of 12.7 mm is cut out by a hot wire slicer, and a marked line is drawn at 38.1 mm from both terminuses in the direction of length. The sample piece is burned by the defined process in FMVSS No. 302, and the combustion speed is measured.

### Example 6

A foamed article was prepared in the same manner as Example 5 except that the amount of styrene was 1808.0 g, the amount of a macromonomer having acryloyl groups at both terminuses prepared in Preparation Example 1 was 113.0 g, and the amount of 2,3-dimethyl-2,3-diphenyl butane was 4.43 g.

### Example 7

A foamed article was prepared in the same manner as Example 5 except that the amount of styrene was 1796.7 g, amount of the macromonomer having acryloyl groups at both terminuses prepared in Preparation Example 1 was 124.3 g, and amount of hexabromocyclododecane was 11.30 g.

### Comparative Example 7

A foamed article was prepared in the same manner as Example 5 except that hexabromocyclododecane and 2,3-dimethyl-2,3-diphenyl butane were not used and the water vapor pressure at molding was adjusted to be 0.10 MPa.

### Comparative Example 8

A foamed article was prepared in the same manner as Example 5 except that 9.04 g of dicumyl peroxide was used instead of 2,3-dimethyl-2,3-diphenyl butane, and the water vapor pressure at molding was adjusted to be 0.09 MPa.

### Comparative Example 9

A foamed article was prepared in the same manner as Example 5 except that the amount of hexabromocyclododecane was 33.90 g and amount of 2,3-dimethyl-2,3-diphenyl butane was 13.29 g.

TABLE 2

| | | | | | Com. | Com. | Com. |
|---|---|---|---|---|---|---|---|
| | | Ex. 5 | Ex. 6 | Ex. 7 | Ex. 7 | Ex. 8 | Ex. 9 |
| macromonomer | part by | 6 | 5 | 5.5 | 6 | 6 | 6 |
| | weight | | | | | | |
| halogen flame retardant | part by | 0.75 | 0.75 | 0.5 | not | 0.75 | 1.5 |
| | weight | | | | used | | |
| radical generating species due to | | 2,3-dimethyl- | 2,3-dimethyl- | 2,3-dimethyl- | not | dicumyl | 2,3-dimethyl- |
| high temperature decomposition | | 2,3-diphenyl | 2,3-diphenyl | 2,3-diphenyl | used | peroxide | 2,3-diphenyl |
| | | butane | butane | butane | | | butane |
| temperature at which the half of | ° C. | 220 | 220 | 220 | not | 116.4 | 220 |
| radical generating species due to high | | | | | used | | |
| temperature decomposition are reduced | | | | | | | |
| in 10 hours | | | | | | | |
| amount of radical generating species due | part by | 0.35 | 0.18 | 0.35 | 0 | 0.4 | 0.5 |
| to high temperature decomposition | weight | | | | | | |
| weight average molecular weight | ten | 22.0 | 22.7 | 23.0 | 24.2 | 21.6 | 21.6 |
| | thousand | | | | | | |
| gel content | % by | 5.82 | 4.77 | 5.74 | 6.28 | 5.59 | 5.48 |
| | weight | | | | | | |
| falling weight method | cm | 26 | 28 | 30 | 30 | 21 | 19 |
| half-broken height calculated by | | | | | | | |
| 30-time conversion | | | | | | | |
| FMVSS No. 302 test | cm/min | not burned | not burned | 9.7 | 17.3 | 10.1 | 9.2 |
| compression test | kgf/cm² | 3.2 | 3.2 | 3.2 | 3.2 | 3.1 | 3.2 |

The foam obtained in the present invention is excellent in balance between the compression strength, the crack resistance and the combustion speed as indicated in Table 2.

### Examples 8 to 11

### Preparation of Expandable Thermoplastic Resin Particles

A 6 L-autoclave equipped with a rotational agitator was charged with 2250 g of distilled water, 3.5 g of calcium tertiary phosphate, and 0.14 g of α-olefin sodium sulfonate. Then, 6 g of benzoyl peroxide, 3.5 g of 1,1-di(t-butylperoxy)cyclohexane, 4.5 g of 2,4-diphenyl-4-methyl-1-pentene and 22.5 g of a palm oil were dissolved into the mixture solution of 1777.5 g of styrene, 337.5 g of acrylonitrile, 135 g of the macromonomer having acryloyl groups at both terminuses prepared in Preparation Example 1 and the mixture was charged into the autoclave. Next, after raising a temperature in the autoclave up to 85° C. and polymerizing at the same temperature for 4 hours, 180 g of mixed butane (weight ratio: normal/iso= 75/25) was charged with pressure, thereafter, a temperature in the autoclave was raised to 115° C., and the mixed butane was immersed into the generated polymer particles by taking for 8 hours. Subsequently, the reaction system was gradually cooled down to a temperature of 30° C., and the polymerization was terminated.

The obtained expandable thermoplastic resin particles were dehydrated by a centrifuging machine, and after drying, classified by the particles diameter in a range of 0.84 to 1.19 mm.

### <Analysis of Expandable Thermoplastic Resin Particles>

The measurements of molecular weight, the measurement of styrene amount and the analysis of gel content were carried out according to the above-described processes.

### (Measurement of Amount of Blowing Agent)

The amount of the blowing agent was measured by loss in weight by heating at 150° C. for 30 minutes. It was 8.2% by weight.

### <Preparation of a Foamed Article>

The pre-foamed particles were obtained by pre-foaming expandable thermoplastic resin particles to have a density of 50 kg/m³ (Example 8), a density of 33.3 kg/m³ (Example 9), a density of 25 kg/m³ (Example 10) and a density of 20 kg/m³ (Example 11) respectively. The pre-foamed particles were aged at a room temperature for one day, then filled within a metal die cavity having the size of 300×600×25 mm, and heated for 20 seconds by water vapor (0.1 MPa) to obtain a foamed article.

### <Measurement of Physical Properties>

Value A (MPa) of the compression strength and the falling weight method were carried out according to the above-described processes.

As for “density” of a foamed article for measuring the compression strength, density C (kg/m³) of the foamed article was found by the following formula in accordance with JIS K 6767.

C=G/V

G: weight (kg) of the foamed article, V: volume (m³) of the foamed article

G and V were calculated by measuring sizes of the weight, length, width, and height of a sample for the compression strength test.

Measurement equipments and the degree of precision were specified in accordance with JIS K 6767.

Also, as for “density” of a foamed article for the falling weight method, density C (kg/m³) of the foamed article was found by the following formula in accordance with JIS K 6767.

C=G/V

G: weight (kg) of the foamed article, V: volume (m³) of the foamed article

As for G and V, sizes of the length, width, and height of a sample for the falling weight method were measured and the average value of 20 test pieces was adopted.

Measurement equipments and the degree of precision were specified in accordance with JIS K 6767.

TABLE 3

| | | Ex. 8 | Ex. 9 | Ex. 10 | Ex. 11 | Ex. 12 | Ex. 13 | Ex. 14 | Ex. 15 |
|---|---|---|---|---|---|---|---|---|---|
| styrene | % by | 79.0 | 79.0 | 79.0 | 79.0 | 71.5 | 71.5 | 71.5 | 71.5 |
| | weight | | | | | | | | |
| acrylonitrile | % by | 15.0 | 15.0 | 15.0 | 15.0 | 22.5 | 22.5 | 22.5 | 22.5 |
| | weight | | | | | | | | |
| macromonomer | % by | 6.0 | 6.0 | 6.0 | 6.0 | 6.0 | 6.0 | 6.0 | 6.0 |
| | weight | | | | | | | | |
| weight average | ×10⁴ | 24.2 | 24.2 | 24.2 | 24.2 | 24 | 24 | 24 | 24 |
| molecular weight | | | | | | | | | |
| remaining styrene | ppm | ND* | ND* | ND* | ND* | ND* | ND* | ND* | ND* |
| amount | | | | | | | | | |
| gel content | % by | 6.3 | 6.3 | 6.3 | 6.3 | 9.4 | 9.4 | 9.4 | 9.4 |
| | weight | | | | | | | | |
| density | kg/m³ | 50 | 33.3 | 25 | 20 | 50 | 33.3 | 25 | 20 |
| falling weight | cm | 50.0 | 35.0 | 27.5 | 23.0 | 49.0 | 34.0 | 26.5 | 22.0 |
| method | | | | | | | | | |
| compression | Mpa | 0.506 | 0.317 | 0.222 | 0.166 | 0.506 | 0.317 | 0.222 | 0.166 |
| test | | | | | | | | | |
| | | Ex. 16 | Ex. 17 | Ex. 18 | Ex. 19 | Ex. 20 | Ex. 21 | Ex. 22 | Ex. 23 |
| styrene | % by | 77.0 | 77.0 | 77.0 | 77.0 | 74.6 | 74.6 | 74.6 | 74.6 |
| | weight | | | | | | | | |
| acrylonitrile | % by | 15.0 | 15.0 | 15.0 | 15.0 | 23.4 | 23.4 | 23.4 | 23.4 |
| | weight | | | | | | | | |
| macromonomer | % by | 8.0 | 8.0 | 8.0 | 8.0 | 2.0 | 2.0 | 2.0 | 2.0 |
| | weight | | | | | | | | |
| weight average | ×10⁴ | 23.2 | 23.2 | 23.2 | 23.2 | 20.2 | 20.2 | 20.2 | 20.2 |
| molecular weight | | | | | | | | | |
| remaining styrene | ppm | ND* | ND* | ND* | ND* | ND* | ND* | ND* | ND* |
| amount | | | | | | | | | |
| gel content | % by | 10.8 | 10.8 | 10.8 | 10.8 | 2.7 | 2.7 | 2.7 | 2.7 |
| | weight | | | | | | | | |
| density | kg/m³ | 50 | 33.3 | 25 | 20 | 50 | 33.3 | 25 | 20 |
| falling weight | cm | 49.0 | 34.0 | 26.5 | 22.0 | 43.0 | 28.0 | 20.5 | 16.0 |
| method | | | | | | | | | |
| compression | Mpa | 0.493 | 0.304 | 0.210 | 0.153 | 0.506 | 0.317 | 0.222 | 0.166 |
| test | | | | | | | | | |

*ND—not detected
**impossible to measure

TABLE 4

| | | Com. | Com. | Com. | Com. | Com. | Com. | Com. | Com. |
|---|---|---|---|---|---|---|---|---|---|
| | | Ex. 10 | Ex. 11 | Ex. 12 | Ex. 13 | Ex. 14 | Ex. 15 | Ex. 16 | Ex. l7 |
| weight average | ×10⁴ | 30 | 30 | 30 | 30 | 27 | 27 | 27 | 27 |
| molecular weight | | | | | | | | | |
| remaining styrene | ppm | 4800 | 4800 | 4800 | 4800 | 4900 | 4900 | 4900 | 4900 |
| amount | | | | | | | | | |
| gel content | % by | 0 | 0 | 0 | 0 | 21.0 | 21.0 | 21.0 | 21.0 |
| | weight | | | | | | | | |
| density | kg/m³ | 50 | 33.3 | 25 | 20 | 50 | 33.3 | 25 | 20 |
| falling weight | cm | 31.5 | 21.0 | 16.0 | 12.5 | 46.5 | 33.5 | 27.0 | 23.0 |
| method | | | | | | | | | |
| compression | Mpa | 0.492 | 0.314 | 0.225 | 0.171 | 0.441 | 0.263 | 0.174 | 0.120 |
| test | | | | | | | | | |

| | | | | | | | |
|---|---|---|---|---|---|---|---|
| Com. | Com. | Com. | Com. | Com. | Com. | Com. | Com. |
| Ex. 18 | Ex. 19 | Ex. 20 | Ex. 21 | Ex. 22 | Ex. 23 | Ex. 24 | Ex. 25 |

| | | | | | | | | | |
|---|---|---|---|---|---|---|---|---|---|
| weight average | ×10⁴ | 32 | 32 | 32 | 32 | 32 | 32 | 32 | 32 |
| molecular weight | | | | | | | | | |
| remaining styrene | ppm | ND* | ND* | ND* | ND* | ND* | ND* | ND* | ND* |
| amount | | | | | | | | | |
| gel content | % by | 3.4 | 3.4 | 3.4 | 3.4 | 11 | 11 | 11 | 11 |
| | weight | | | | | | | | |
| density | kg/m³ | 50 | 33.3 | 25 | 20 | 50 | 33.3 | 25 | 20 |
| falling weight | cm | 29.5 | 19.0 | 14.0 | 10.5 | 21.5 | 11.0 | 6.0 | 2.5 |
| method | | | | | | | | | |
| compression | Mpa | 0.485 | 0.307 | 0.218 | 0.164 | 0.463 | 0.285 | 0.196 | 0.143 |
| test | | | | | | | | | |

*ND: not detected
**impossible to measure

TABLE 5

| | | Com. | Com. | Com. | Com. | Com. | Com. |
|---|---|---|---|---|---|---|---|
| | | Ex. 26 | Ex. 27 | Ex. 28 | Ex. 29 | Ex. 30 | Ex. 31 |
| styrene | % by | 75.9 | 75.9 | 75.9 | 75.9 | 76.1 | 76.1 |
| | weight | | | | | | |
| acrylonitrile | % by | 23.8 | 23.8 | 23.8 | 23.8 | 23.9 | 23.9 |
| | weight | | | | | | |
| macromonomer | % by | 0.3 | 0.3 | 0.3 | 0.3 | 0 | 0 |
| | weight | | | | | | |
| weight average | ×10⁴ | 20 | 20 | 20 | 20 | 19.3 | 19.3 |
| molecular weight | | | | | | | |
| remaining styrene | ppm | ND* | ND* | ND* | ND* | ND* | ND* |
| amount | | | | | | | |
| gel content | % by | 0.3 | 0.3 | 0.3 | 0.3 | 0 | 0 |
| | weight | | | | | | |
| density | kg/m³ | 50 | 33.3 | 25 | 20 | 50 | 33.3 |
| falling weight | cm | 36.0 | 21.0 | 13.5 | 9.0 | 31.5 | 21.5 |
| method | | | | | | | |
| Compression | Mpa | 0.506 | 0.317 | 0.222 | 0.166 | 0.463 | 0.285 |
| test | | | | | | | |
| | | Com. | Com. | Com. | Com. | Com. | Com. |
| | | Ex. 32 | Ex. 33 | Ex. 34 | Ex. 35 | Ex. 36 | Ex. 37 |
| styrene | % by | 76.1 | 76.1 | | | | |
| | weight | | | | | | |
| acrylonitrile | % by | 23.9 | 23.9 | | | | |
| | weight | | | | | | |
| macromonomer | % by | 0 | 0 | | | | |
| | weight | | | | | | |
| weight average | ×10⁴ | 19.3 | 19.3 | 51.3 | 51.3 | 51.3 | 51.3 |
| molecular weight | | | | | | | |
| remaining styrene | ppm | ND* | ND* | 250 | 250 | 250 | 250 |
| amount | | | | | | | |
| gel content | % by | 0 | 0 | 19.4 | 19.4 | 19.4 | 19.4 |
| | weight | | | | | | |
| density | kg/m³ | 25 | 20 | 50 | 33.3 | 25 | 20 |
| falling weight | cm | 16.0 | 13.0 | 52.5 | 39.5 | 33.0 | 29.0 |
| method | | | | | | | |
| Compression | Mpa | 0.196 | 0.143 | 0.323 | 0.191 | 0.125 | 0.086 |
| test | | | | | | | |

*ND—not detected
**impossible to measure

### Examples 12 to 15

Examples 12 to 15 were carried out in the same manner as Examples 8 to 11 except that the amount of styrene to be charged was 1609.5 g and the amount of acrylonitrile to be charged was 505.5 g.

### Examples 16 to 19

Examples 16 to 19 were carried out in the same manner as Examples 8 to 11 except that the amount of styrene to be charged was 1732.5 g and the amount of a macromonomer having acryloyl groups at both terminuses to be charged was 180 g.

### Examples 20 to 23

Examples 20 to 23 were carried out in the same manner as Examples 8 to 11 except that the amount of styrene to be charged was 1678 g, the amount of acrylonitrile to be charged was 527 g and the amount of a macromonomer having acryloyl groups at both terminuses to be charged was 45 g.

### Comparative Examples 10 to 13

A molded article was prepared in the same manner as Examples 8 to 11 except for using an expandable polystyrene resin particles (product name: KANEPEARL NSG available from KANEKA CORPORATION) was used.

### Comparative Examples 14 to 17

Expandable modified styrene resin particles were obtained in accordance with the description of Example 2 in WO2001/048068 pamphlet. Except for that, a molded article was prepared in the same manner as Examples 8 to 11.

### Comparative Examples 18 to 21

A molded article was prepared in the same manner as Examples 8 to 11 except that the amount of styrene to be charged was 2250 g, the amount of acrylonitrile to be charged was 0 g, the amount of a macromonomer having acryloyl groups at both terminuses to be charged was 0 g, and 0.45 g of divinylbenzene was added.

### Comparative Examples 22 to 25

A molded article was prepared in the same manner as Examples 8 to 11 except that the amount of styrene to be charged was 2250 g, the amount of acrylonitrile to be charged was 0 g, the amount of a macromonomer having acryloyl groups at both terminuses to be charged was 0 g, and 1.35 g of divinylbenzene was added.

### Comparative Examples 26 to 29

A molded article was prepared in the same manner as Examples 8 to 11 except that the amount of styrene to be charged was 1707.1 g, the amount of acrylonitrile to be charged was 536.1 g, and the amount of a macromonomer having acryloyl groups at both terminuses to be charged was 6.75 g.

### Comparative Examples 30 to 33

A molded article was prepared in the same manner as Examples 8 to 11 except that the amount of styrene to be charged was 1712.3 g, the amount of acrylonitrile to be charged was 537.8 g, and the amount of a macromonomer having acryloyl groups at both terminuses to be charged was 0 g.

### Comparative Examples 34 to 37

A styrene modified polyethylene foamed article was prepared in accordance with the description of Example 1 in JP-A-8-59754.

As shown in Tables 3 to 5, the foamed article obtained in the present invention has high compression strength and high crack resistance, thus, is the most suitable for foamed parts for an automobile.

### INDUSTRIAL APPLICABILITY

According to the present invention, a foamed article having high compression strength and high crack resistance can be provided. Due to having such properties, the formed article is suitable for light-weighted plastic parts, heat insulating parts for architecture, and cushioning materials which are used under the condition where the materials are repeatedly dropped. Moreover, according to the present invention, a foamed article having the high crack resistance and the high compression strength, which are suitable for automobile interior, and a low combustion speed can be provided. Particularly, the foamed article can be suitably used for the automobile interior such as a floor spacer, tool box, and tibia pad. Further, the present invention can provide foamed parts for an automobile having both of the high crack resistance and the high compression strength. The foamed parts for an automobile of the present invention is suitable for a parts which is required to relax and/or absorb the impact in the automobile, a parts which is required to withstand load and the like such as a tibia pad, energy absorber for head, side impact energy absorber, bumper core, floor spacer and tool box.

1. Expandable thermoplastic resin particles, which are obtained by containing a blowing agent into a thermoplastic resin obtained by a polymerizing monomer mixture, wherein a macromonomer is contained in said monomer mixture and a gel content of a foamed article obtained from said expandable thermoplastic resin particles is 1 to 40% by weight.

2. The expandable thermoplastic resin particles of claim 1, wherein a vinyl monomer is contained in said monomer mixture.

3. The expandable thermoplastic resin particles of claim 1, wherein the amount of said macromonomer is 1 to 20% by weight in the monomer mixture.

4. The expandable thermoplastic resin particles of claim 2, wherein said vinyl monomer is a styrene monomer.

5. The expandable thermoplastic resin particles of claim 2, wherein said vinyl monomer is a mixed monomer of a styrene monomer and a vinyl cyanide monomer.

6. The expandable thermoplastic resin particles of claim 5, wherein the amount of said vinyl cyanide monomer is 10 to 30% by weight in the monomer mixture.

7. The expandable thermoplastic resin particles of claim 1, wherein the amount of styrene monomer contained in the expandable thermoplastic resin particles is at most 1000 ppm.

8. The expandable thermoplastic resin particles of claim 1, wherein said macromonomer is a macromonomer having at least two terminuses wherein the terminus contains at least one polymerizable reactive group.

9. The expandable thermoplastic resin particles of claim 1, wherein the glass transition temperature of said macromonomer is at most −20° C.

10. The expandable thermoplastic resin particles of claim 1, wherein a monomer constituting a main chain in a polymer of said macromonomer is an acrylic ester monomer and/or an methacrylic ester monomer.

11. The expandable thermoplastic resin particles of claim 10, wherein said acrylic ester monomer is ethyl acrylate and/or butyl acrylate.

12. The expandable thermoplastic resin particles of claim 8, wherein at least one of polymerizable reactive groups contained at terminuses in the macromonomer is a carbon-carbon double bond.

13. The expandable thermoplastic resin particles of claim 12, wherein the group having a carbon-carbon double bond contained at terminuses in the macromonomer is a group represented by the following general formula (1):
—OC(O)C(R)═CH₂ (1)
(wherein R represents a hydrogen atom or an organic group having 1 to 20 carbon atoms).

14. The expandable thermoplastic resin particles of claim 13, wherein R represents a hydrogen atom or a methyl group.

15. The expandable thermoplastic resin particles of claim 1, wherein the expandable thermoplastic resin particles are obtained by containing a blowing agent into a particulate thermoplastic resin particles.

16. The expandable thermoplastic resin particles of claim 15, wherein the amount of the blowing agent contained in the thermoplastic resin particles is 3 to 15% by weight.

17. The expandable thermoplastic resin particles of claim 1, comprising a halogen flame retardant and a compound which generates radical species due to high temperature decomposition having a 10 hours half-life temperature of at least 120° C.

18. The expandable thermoplastic resin particles of claim 17, comprising 0.25 to 1.20 parts by weight of a halogen flame retardant based on 100 parts by weight of the thermoplastic resin and a compound which generates radical species due to high temperature decomposition having a 10 hours half-life temperature of at least 120° C.

19. The expandable thermoplastic resin particles of claim 18, comprising 0.1 to 0.5 part by weight of a compound which generates radical species due to high temperature decomposition based on 100 parts by weight of the thermoplastic resin.

20. Expanded particles, which are obtained by pre-foaming the expandable thermoplastic resin particles of claim 1.

21. A thermoplastic resin foamed article, which is obtained by molding the expanded particles of claim 20.

22. A thermoplastic resin foamed article of claim 21, wherein the expansion ratio is at most 60 times.

23. The thermoplastic resin foamed article of claim 21, wherein the combustion speed is at most 10 cm/minute in FMVSS No. 302 test.

24. Foamed parts for an automobile comprising a foamed article having the density of 16.6 to 100 kg/m³, wherein the relationship among compression strength A (MPa) at 25% strain of said foamed article in a static compression test, a 50% failure height B (cm) in said foamed article in falling weight method of the foamed article, and a density C (kg/m³) of said foamed article satisfies both of the following formulas (2) and (3):
A≧0.0113×C−0.09 (2)
B≧0.9×C−3.5 (3)

25. The foamed parts for an automobile of claim 24, wherein said foamed article is a thermoplastic resin foamed article obtained by molding the expanded particles obtained by foaming the expandable thermoplastic resin particles obtained by containing the blowing agent into the thermoplastic resin obtained by polymerizing monomer mixture comprising a macromonomer, and wherein the gel content of said thermoplastic resin foamed article is 1 to 40% by weight.

26. The foamed parts for an automobile of claim 24, wherein said foamed article is a thermoplastic resin foamed article obtained by molding the expanded particles obtained by foaming a expandable thermoplastic resin particle obtained by containing a blowing agent into a thermoplastic resin obtained by polymerizing monomer mixture comprising a styrene monomer, a vinyl cyanide monomer, and an acrylic ester macromonomer having at least two terminuses wherein the terminus contains at least one polymerizable reactive group.

27. The foamed parts for an automobile of claim 24, which is any one of a tibia pad, energy absorber for head, side impact energy absorber, bumper core, floor spacer and tool box.
